(19) United States
(12) Patent Application Publication
(10) Pub. No.: US 2003/0042275 A1
(43) Pub. Date: Mar. 6, 2003

(54) Single application solder pellet, soldering gun having a wheel dispenser, solder pellet dispenser, and method of soldering

(76) Inventor: Gina Kaye, Chicago, IL (US)

Correspondence Address: Robert S. Beiser, Esq., Michael Best & Friedrich LLC, 401 North Michigan Avenue, #1900, Chicago, IL, 60611, US

(21) Appl. No.: 09/941,976

(22) Filed: Aug. 29, 2001

(51) Int. Cl. B23K 35/14

(52) U.S. Cl. 222/594; 228/56.3

(57) ABSTRACT

A soldering gun, a solder pellet having a predetermined amount of solder, solder pellet dispensing wheel, kit related thereto and method of soldering is provided herein. The present invention provides a device for dispensing solder that includes a dispensing wheel that has a plurality of radially disposed dispensing wheel solder pellet retaining compartments. The compartments are sized to accommodate a predetermined size, single application solder pellet. The kit for dispensing solder comprises at least two of a fine solder pellet dispensing wheel having a plurality of fine solder pellets, a medium solder pellet dispensing wheel having a plurality of medium solder pellets, or a thick solder pellet dispensing wheel having a plurality of thick solder pellets. The kit also includes a portable, hand held, soldering device mating with the solder dispensing wheel. The portable, hand held, soldering device, includes a solder pellet holder dimensioned for a predetermined amount, single application of solder onto a substrate, and is generally in the size and shape of a gun. The portable, hand held, soldering device includes a first holding chamber providing a first heating point, a second chamber connected to the first holding chamber and providing a flash heating point, and a dispenser tip connected to the second holding chamber. The dispenser tip provides a flash heating point and has a release point for releasing the predetermined amount, single application of solder onto the substrate. The dispenser tip is connected to the first holding chamber and provides a flash heating point, and has a release point for releasing the predetermined amount, single application of solder onto a substrate.

### BACKGROUND OF THE INVENTION

This invention generally relates to solder pellets, soldering guns, solder pellet dispensers, and methods of soldering. Currently, consumers in this field of technology are using devices that include soldering irons and coils of solder with and without built-in solder flux. The devices in the art have a variety of drawbacks which include problems with accurately positioning the solder, slow solder application speeds, and lack of repeatability of solder dispensing. These devices also require significant amounts of energy to melt variable segments of solder from a coil. It is an object of this invention to solve the problems in the art.

### SUMMARY OF THE INVENTION

The present invention provides a device for dispensing solder that includes a dispensing wheel that has a plurality of radially disposed dispensing wheel solder pellet retaining compartments. The compartments are sized to accommodate a predetermined size, single application solder pellet.

In another aspect, the invention provides a kit for dispensing solder comprising at least two of a fine solder pellet dispensing wheel having a plurality of fine solder pellets, a medium solder pellet dispensing wheel having a plurality of medium solder pellets, or a thick solder pellet dispensing wheel having a plurality of thick solder pellets. The kit also includes a portable, hand held, soldering device mating with the solder dispensing wheel.

The portable, hand held, soldering device, includes a solder pellet holder dimensioned for a predetermined amount, single application of solder onto a substrate, and is generally in the size and shape of a gun. The portable, hand held, soldering device includes a first holding chamber providing a first heating point, a second chamber connected to the first holding chamber providing a flash heating point, and a dispenser tip connected to the second holding chamber. The dispenser tip provides a flash heating point and has a release point for releasing the predetermined amount, single application of solder onto the substrate. The dispenser tip is connected to the first holding chamber and provides a flash heating point, and has a release point for releasing the predetermined amount, single application of solder onto a substrate. The portable device has a dual function trigger having a partial mode of actuation and a full mode of actuation. The dual function trigger includes a first trigger to provide for the partial mode of actuation, and a second trigger to provide for the full mode of actuation.

In yet another aspect, the invention includes a solder pellet which is dimensioned and weighted for a single application thereof onto a solder accepting substrate. The solder pellet is substantially cylindrical or spherical in a pre-molten state.

In yet a further aspect, the invention includes a method of applying solder with a portable, hand held, solder gun. The steps include dispensing a predetermined measure, single application solder pellet from a dispensing wheel temporarily retaining a plurality of predetermined measure, single application solder pellets, to a pre-heating chamber to form a pre-heated single application solder pellet, flash heating the pre-heated single application solder pellet to an effective temperature to form a flash heated single application solder pellet, and releasing the flash heated single application solder pellet onto a solder accepting substrate.

The objects and features of the present invention, other than those specifically set forth above, will become apparent in the detailed description of the invention and drawings set forth below.

### BRIEF DESCRIPTION OF THE DRAWINGS

FIG. 1 is a side view of the multi-function soldering gun of the present invention;

FIG. 2 is side view of a solder pellet dispensing wheel of the present invention;

FIG. 3 is a side view of a dispensing tip of the present invention;

FIG. 4 is an exploded side view of the dispensing wheel of FIG. 2;

FIG. 5 is an exploded side view of the soldering gun of FIG. 1 illustrating a solder pellet exiting the dispensing wheel at an opening and entering a pre-heating chamber of the soldering gun;

FIG. 6 illustrates a variant of the dispensing wheel of FIG. 2 having outer gears thereon and an internal gear drive disposed in the housing of the soldering gun of FIG. 1;

FIG. 7 illustrates a side exploded view of the dispensing wheel of FIG. 2, the pre-heating chamber of FIG. 5, and a second flash heating point chamber connected to the pre-heating chamber;

FIG. 8 is a perspective view of a solder pellet of the present invention; and,

FIG. 9 is a side view of a kit of the present invention.

### DETAILED DESCRIPTION OF THE INVENTION

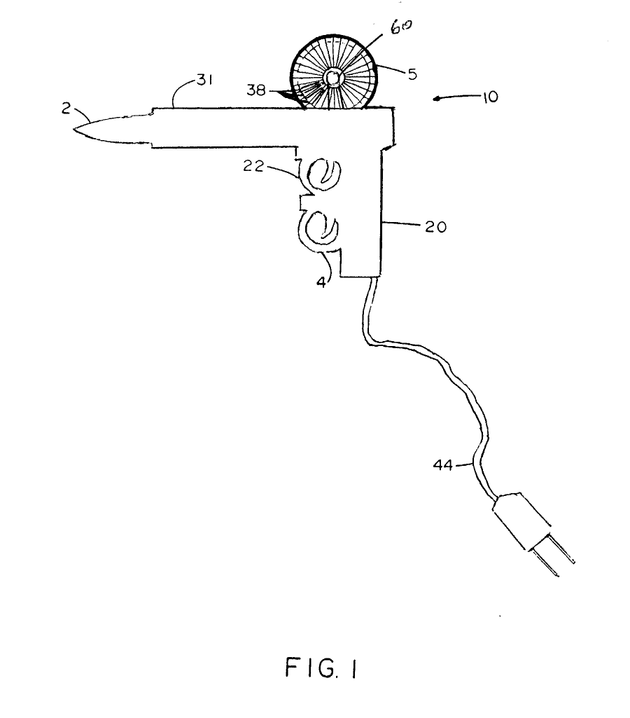

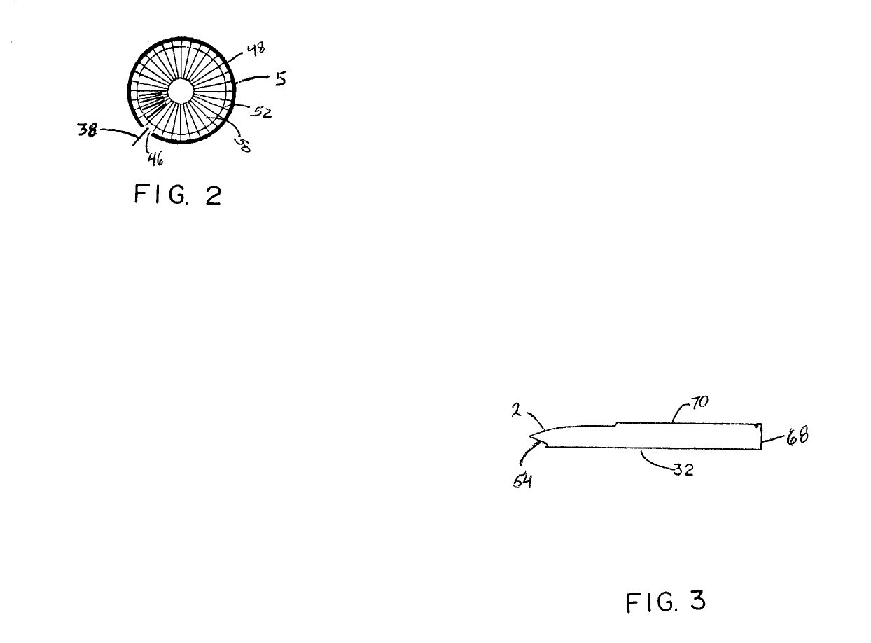

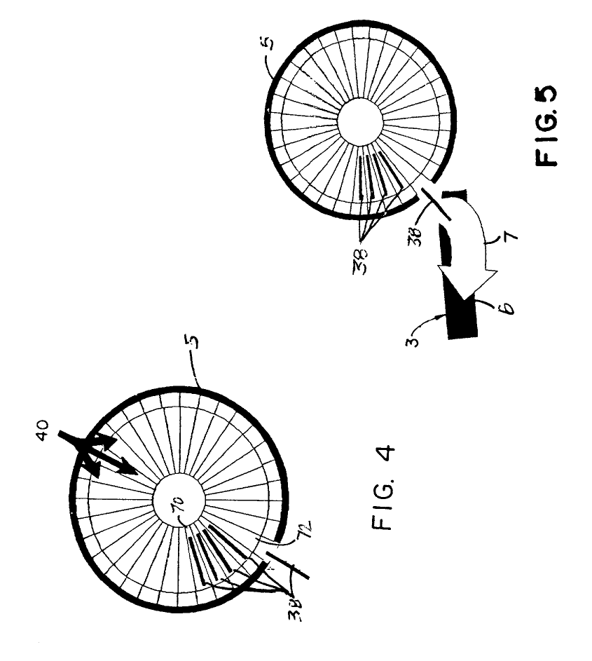

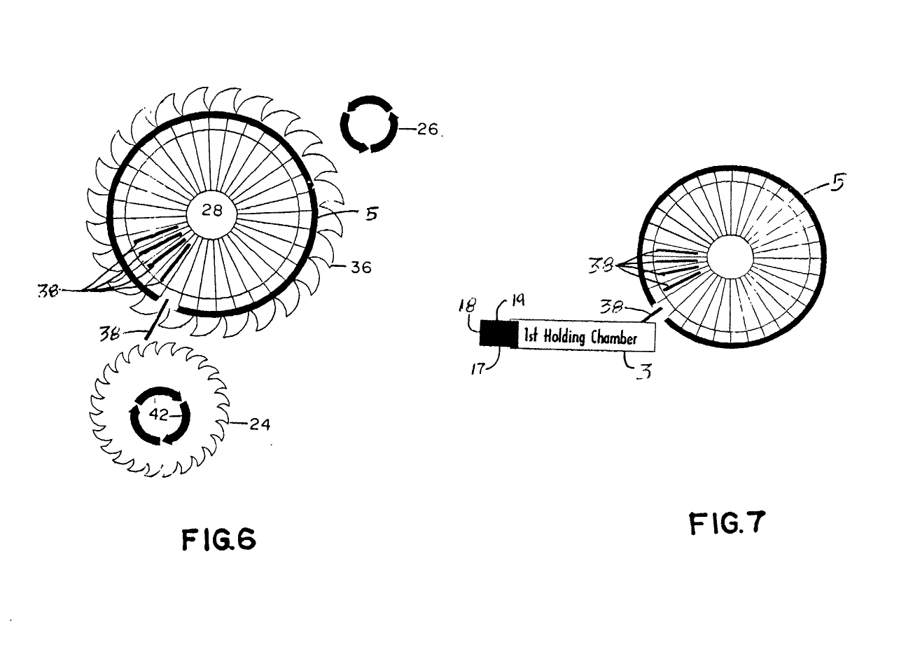

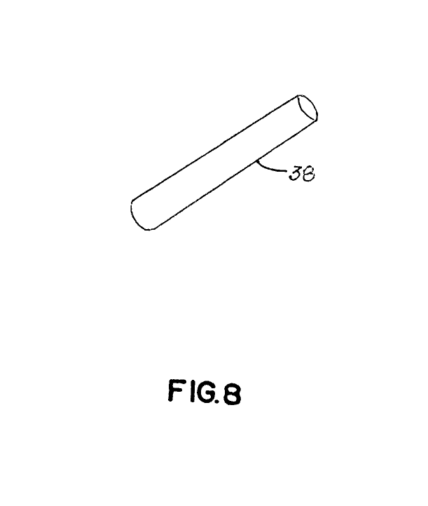

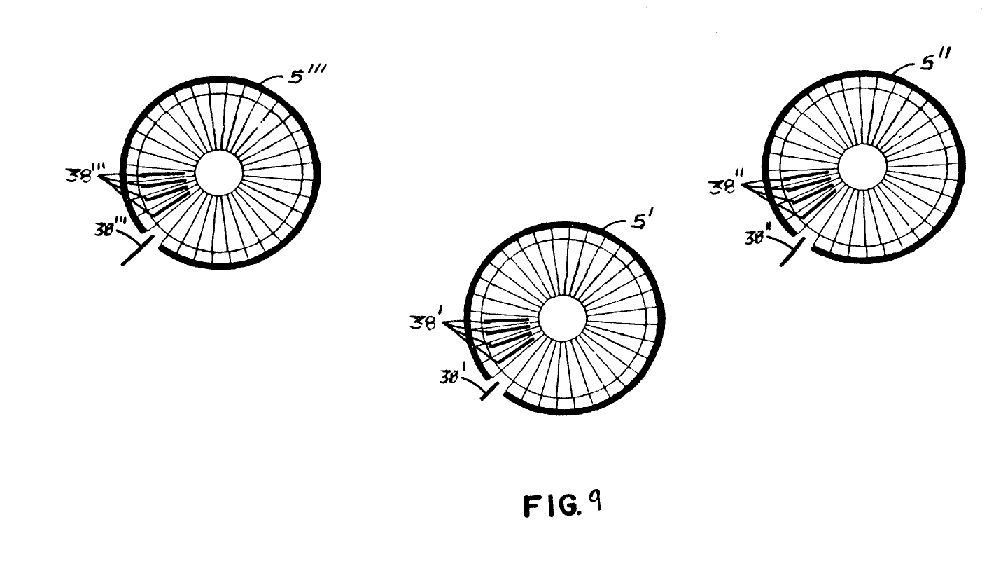

FIG. 1 illustrates ergonomic, portable, hand held, soldering device 10. Soldering device 10 includes solder dispensing wheel 5. Solder dispensing wheel 5 has a plurality of compartments 40 (FIG. 4). Each compartment 40 is sized and dimensioned for temporarily storing a predetermined amount, single application of solder 38 (FIGS. 1, 2 and 4-7). Top portion 70 of compartment 40 is generally narrower than bottom portion 72 to provide ease of exit of solder pellet 38 from compartment 40 in one variant thereof. Solder dispensing wheel 5 can be constructed so that wheel 5 serves as a solder pellet holder dimensioned to retain a predetermined amount, substantially solid, single application of solder 38 prior to expulsion of solder 38 into the processing chambers 3, 17 of device 10 and onto a substrate (not shown). Wheel 5 can also take the form of a revolver barrel or the like.

Soldering device 10 includes hand grip member 20, power cord 44 extending from the base of hand grip member 20, and upper dispenser tip retaining body member 31 for removably retaining dispenser tip 2 within said body member 31. Device 10 is generally substantially in the size and shape of a gun as illustrated in FIG. 1. It is appreciated that solder device 10 can also include other ergonomic features and hand grip member 20 can be disposed linearly with respect to upper dispenser tip retaining body member 31 with dispensing wheel 5 being located at any convenient location on the linear combination of members 20, 31. Members 20, 31 are generally constructed of a rigid, molded, non-heat transferring plastic or other material.

Soldering device 10 includes first inner holding chamber 3 (FIGS. 5 and 7). First holding chamber 3 provides a first heating point for solder pellet 38. As illustrated in FIG. 5, solder pellet 38 exits compartment 40 and enters first inner holding chamber 3 for processing thereof as indicated by directional dispensing arrow 7. First inner holding chamber 3 is generally hollow and constructed of a heat transferring material as a metal and the like. Optionally, chambers 3, and second chamber 17 (FIG. 7) can be coated with a material, such as Teflon or other material known in the art which will not cause solder pellet 38 to stick to chambers 3, 17 during the processing of solder pellet 38. It is appreciated that this type of coating with increase the movement of partially processed of fully processed solder pellet 38 through device 10 for application on a substrate of interest.

Second chamber 17 is also generally hollow and is constructed of a metal. Second chamber 17 is connected to first holding chamber 3 such that passage of solder pellet 3 is permitted upon actuation of trigger first heat chamber releasing trigger 22. Means for temporarily limit stopping the passage of solder pellet 38 within the various chambers 3, 17 can include mechanically or electrically actuated doors or shutters that permit the sequential flow of solder pellet 38 (in a preheated or molten state) to the desired chambers 3, 17. Second chamber 17 provides flash heating point 19 which melts or substantially fluidizes solder pellet 38 so that it can be dispensed from device 10 through second chamber release point 18 of second chamber 17 (FIG. 7).

After processing and release of solder pellet 38 in chambers 3, 17, the processed solder pellet enters dispenser tip 2 communicatively connected to second holding chamber 17. Dispenser tip 2 provides flash heating point 19 in one variant of the invention upon actuation of surface releasing trigger 4. Dispenser tip 2 includes aperture 54 (FIG. 3) that is a release point for releasing predetermined amount, single application of solder 38 onto a substrate (not shown). Dispenser tip is constructed from the same types of materials as chambers 3, 17 and is generally hollow and formed from a shell of metal or metallic material.

In a variant of the invention, chamber 17 is eliminated. Dispenser tip 2 communicates directly with first holding chamber 3 with gun mating end 56 of tip 2 abutting chamber 3. In this variant, dispenser tip 2 provides flash heating point 19 prior to release of the processed solder pellet 38 on a substrate. Dispenser tip 2 includes a substantially flat bottom portion 32. The dispenser tip is generally removably inserted into dispenser tip retaining body member 31 of device 10.

Soldering device 10 also includes a single, dual function trigger (not shown). The single dual function trigger has a partial mode of actuation and a full mode of actuation. The partial mode of actuation provides for movement of the predetermined amount, single unit application of solder 38 from solder pellet holder, dispensing wheel 5 to first holding chamber 3 and actuates electrical preheating of predetermined amount, single application of solder 38 to form a preheated solder pellet. The full mode of actuation of the trigger provides for movement of the preheated solder pellet from first holding chamber 3 to second chamber 17 for sequential flash heating and release of the preheated solder pellet from soldering device 10 onto a substrate. It is appreciated that variable actuation of a trigger can actuate one or more of the processing functions described herein, and that one or more doors or shutters can be provided to assist movement and blockage of the solder pellet as needed in the chambers 3, 17 of the device. Arrows 26 (FIG. 6) indicate the rotation of wheel 5, while arrows 42 indicate the rotational movement of gear drive 24.

As illustrated in FIG. 1, the dual function trigger includes first trigger 22 to provide for the partial mode of actuation, and second trigger 4 to provide for the full mode of actuation. Initiation of the partial mode of actuation permits movement of the predetermined single application of solder 38 from compartment 40 through opening 46 on solder dispensing wheel 5 into first inner holding chamber 3. In a variant of the invention, either a partial mode of actuation or a full mode of actuation advances solder dispensing wheel 5 at a predetermined increment to subsequent compartment 40 having a new predetermined amount, single application of solder 38 therein. Partial mode of actuation engages internal gear drive 24 (FIG. 6) rotatably engaging dispensing wheel outer turning gears 36 to rotationally advance dispensing wheel 5. As illustrated in the accompanying drawings, solder dispensing wheel 5 is substantially circular but can take on any other appropriate size and shape for dispensing solder pellets 38.

A device for dispensing solder pellets 38 is also provided. Dispensing wheel 5 includes a plurality of radially disposed dispensing wheel solder pellet retaining compartments 40. Device 5 includes substantially circular body member 48. Body member is constructed of a rigid plastic or other suitable material and at least partially encloses radially disposed dispensing wheel solder pellet retaining compartments 40. Body member 48 also includes a pellet dispensing opening or egress means through which predetermined size, single application solder pellets 38 exit. In a variant, dispensing wheel solder pellet retaining compartments 40 rotate within substantially circular body member 48 which includes means for removably locking body member 48 onto device 10. Preferably, substantially circular body member 48 is formed of a transparent or translucent material for viewing of solder pellet compartments 40. In this way it is possible to determine the number of solder pellets 38 remaining for use within the dispensing wheel 5. In yet a further variant, centrally disposed aperture 28 is dimensioned to mate with a dispensing wheel arm 60 of solder gun 10.

In yet another variant, substantially circular body member 48 has a plurality of circumferentially disposed outer gears 36 thereon connected to dispensing wheel solder pellet retaining compartments 40 used to incrementally advance the compartments within wheel five from one compartment to another compartment. The dispensing wheel solder pellet retaining compartments 40 comprise separating ribs 50 (FIG. 20) connected to dispensing wheel outer turning gears 36. Separating ribs 50 are connected one to another by a separating rib support member 52.

As shown in FIG. 9, the invention includes kit 64 for dispensing solder comprising at least two of a fine solder pellet dispensing wheel 5′ having a plurality of fine solder pellets 38′, a medium solder pellet dispensing wheel 5″ having a plurality of medium solder pellets 38″, or a thick solder pellet dispensing wheel 5′″ having a plurality of thick solder pellets 38′″. The kit 64 optionally includes portable, hand held, soldering device 10 that mates with solder dispensing wheel 5. Fine solder pellets 38′ are in the range of 1 mm to 5 mm in length and 1 mm to 5 mm in diameter. Medium solder pellets 38″ are in the range of 6 mm to 10 mm in length and 6 mm to 10 mm in diameter. Thick solder pellets 38′″ are in the range of 11 mm to greater than about 250 mm in length and 11 mm to greater thank about 250 mm in diameter. Other appropriate sizes for the solder pellets can be determined empirically such that the solder pellet 38 is dimensioned and weighted for a single application thereof onto a solder accepting substrate. As illustrated in FIG. 8, solder pellet 38 is substantially cylindrical in a pre-molten state or substantially spherical in a pre-molten state. Solder pellet 38 can also be of any appropriate three dimensional geometric shape as dictated by device 10 or compartment 40 that provides for ease of movement of the solder pellet 38 through the exit aperture on dispensing wheel 5. It is understood that solder pellet 38 should generally not have edges thereof that would cause the pellet 38 to catch and not exit by force of gravity from compartment 40, or be of a geometric shape that causes the solder pellet not to exit properly. In that regard solder pellet 38 can also have rounded or bull nose ends that assist in the pellet egressing from compartment 40. It is further appreciated that solder pellet should generally be of a geometric shape that should roll out of compartment 40 and into chamber 3 relatively easily.

FIG. 3 illustrates solder pellet dispensing tip 32 which includes substantially hollow dispenser tip housing 70 with a gun mating end 68 at one end thereof and a solder pellet release end 54 at a second end thereof. The housing 70 has means for providing flash heat to a solder pellet resting therein.

The invention also includes a method of applying solder with a portable, hand held, solder gun. The method includes the steps of dispensing a predetermined measure, single application solder pellet 38, 38′, 38″, and 38′″ from dispensing wheel 5 temporarily retaining a plurality of predetermined measure, single application solder pellets 38 to pre-heating chamber 3 to form a pre-heated single application solder pellet (not shown). The method also includes the step of flash heating the pre-heated single application solder pellet to an effective temperature to form a flash heated single application solder pellet (not shown), and releasing the flash heated single application solder pellet onto a solder accepting substrate (not shown). Effective temperatures for heating the solder pellet are determined empirically.

The method also includes the step of releasing the predetermined measure, single application solder pellet 38 from retaining compartment 40 into pre-heating chamber 3, and advancing dispensing wheel 5 incrementally to allow for a sequential predetermined measure, single application solder pellet 38 to enter pre-heating chamber 3. Solder pellet 38 can also contain an effective amount of flux therein or means can be provided in chambers 3, 17 to mix flux with solder pellet 38.

It is further appreciated that respective solder pellets 38′, 38″, 38′″ are analogously sized such that each respective solder pellet within a respective wheel 5′, 5″, 5′″ provides a consistent dosage of solder for a respective application.

It is also appreciated that solder pellets 38, 38′, 38″, 38′″ can also contain a precious or semi-precious metal therein at concentrations and weight percentages that would permit for ease of soldering. Exemplary of such metals include gold, silver, platinum and other metals used in jewelry and the like. Further, it is appreciated that other metallurgical elements and coloring agents can be added to the solder pellets to achieve a desired aesthetic appearance and the like. Other solders that are used in the invention include gold repair solders, white repair solders, pink repair solders, green repair solders, yellow plumb repair solders, white plumb gold solders, silver solders, general plumb solders, white plumb solders, platinum solders, silver solders, standard gold solders, standard white gold solders, standard pink gold solders, and standard green gold solders. These jewelry type solders can be in the range of about 24K to 1K, of varying designations, e.g. hard, medium and soft, have flow points in the range of about 1000° F.-1600° F., and have melt points in the range of about 1000° F.-1600° F. It is understood that device 10 further includes circuitry and means for providing variable control of the radiant energy in chambers 3, 17 so that an appropriate melting point and flow point can be achieved in a respective chamber so allow for the solder to be applied to the substrate of interest. It is appreciated that dispensing wheel 5 can include pellets of varying precious and semi-precious metal concentrations as appropriate.

While only a few, preferred embodiments of the invention have been described hereinabove, those of ordinary skill in the art will recognize that the embodiment may be modified and altered without departing from the central spirit and scope of the invention. Thus, the preferred embodiment described hereinabove is to be considered in all respects as illustrative and not restrictive, the scope of the invention being indicated by claims appended hereto, rather than by the foregoing description, and all changes which come within the meaning and range of equivalency of the claims are intended to be embraced herein.

I claim:

1. A device for dispensing solder comprising a dispensing wheel having a plurality of radially disposed dispensing wheel solder pellet retaining compartments, each said compartment sized to accommodate a predetermined size, single application solder pellet.

2. The device for dispensing solder of claim 1 further comprising a substantially circular body member at least partially enclosing said radially disposed dispensing wheel solder pellet retaining compartments and having a pellet dispensing opening through which said predetermined size, single application solder pellets exit.

3. The device for dispensing solder of claim 1 in which said dispensing wheel solder pellet retaining compartments rotate about an axis within said substantially circular body member.

4. The device for dispensing solder of claim 3 in which said substantially circular body member is formed of a transparent or translucent material for viewing of said solder pellet compartments and contents thereof.

5. The device for dispensing solder of claim 1 further comprising a centrally disposed aperture dimensioned to mate with a dispensing wheel arm of a solder gun.

6. The device for dispensing solder of claim 1 in which said substantially circular body member has a plurality of circumferentially disposed outer gears thereon connected to said dispensing wheel solder pellet retaining compartments.

7. The device for dispensing solder of claim 1 in which said dispensing wheel solder pellet retaining compartments comprise separating ribs connected to dispensing wheel outer turning gears.

8. The device for dispensing solder of claim 7 in which said separating ribs are connected one to another by a separating rib support member.

9. A kit for dispensing solder comprising at least two of a fine solder pellet dispensing wheel having a plurality of fine solder pellets, a medium solder pellet dispensing wheel having a plurality of medium solder pellets, or a thick solder pellet dispensing wheel having a plurality of thick solder pellets, each said dispensing wheel having a plurality of radially disposed dispensing wheel solder pellet retaining compartments sized to temporarily hold said solder pellets, and each said compartments sized to accommodate a single solder pellet.

10. A kit for dispensing solder of claim 9 further comprising a portable, hand held, soldering device mating with said solder dispensing wheel.

11. A solder pellet which is geometrically dimensioned and weighted to readily roll out of a solder dispensing wheel storage compartment by force of gravity, and sized for a single application thereof onto a solder accepting substrate.

12. The solder pellet of claim 11 in which said pellet is substantially cylindrical in a pre-molten state, whereby egress of said pellet from a dispensing wheel aperture is greatly facilitated.

13. The solder pellet of claim 11 in which said pellet is substantially spherical in a pre-molten state, whereby egress of said pellet from a dispensing wheel aperture is greatly facilitated.

14. A solder pellet dispensing tip having a substantially hollow dispenser tip housing with a gun mating end at one end thereof and a solder pellet release end at a second end thereof, said housing having a flash heat providing portion.

15. A method of applying solder with a portable, hand held, solder gun comprising the steps of dispensing a predetermined measure, single application solder pellet from a dispensing wheel temporarily retaining a plurality of said predetermined measure, single application solder pellets to a pre-heating chamber to form a pre-heated single application solder pellet, flash heating said pre-heated single application solder pellet to an effective temperature to form a flash heated single application solder pellet, and releasing said flash heated single application solder pellet onto a solder accepting substrate.

16. The method of claim 15 in which said dispensing wheel has a plurality of radially disposed dispensing wheel solder pellet retaining compartments, each said compartments sized to accommodate said predetermined measure, single application solder pellet, and further comprising the step of releasing said predetermined measure, single application solder pellet from said retaining compartment into said pre-heating chamber.

17. The method of claim 16 further comprising the step of advancing said dispensing wheel incrementally to allow for a sequential premeasured, single application solder pellet to enter said pre-heating chamber.

18. The solder pellet of claim 11 in which said pellet further comprises an effective amount of flux.

19. In a portable, hand held, soldering device, the improvement comprising a solder pellet holder dimensioned for a premeasured amount, single application of solder onto a substrate.

20. A soldering device of claim 19 substantially in the size and shape of a gun.

21. The soldering device of claim 19 further comprising a first holding chamber providing a first heating point.

22. The soldering device of claim 21 further comprising a second chamber connected to said first holding chamber and providing a flash heating point.

23. The soldering device of claim 22 further comprising a dispenser tip connected to said second holding chamber, said dispenser tip providing said flash heating point and having a release point for releasing said predetermined amount, single application of solder onto said substrate.

24. The soldering device of claim 21 further comprising a dispenser tip connected to said first holding chamber, said dispenser tip providing a flash heating point and having a release point for releasing said predetermined amount, single application of solder onto a said substrate.

25. The soldering device of claim 22 further comprising a dual function trigger having a partial mode of actuation and a full mode of actuation, said partial mode of actuation providing for movement of said predetermined amount, single unit application of solder from said solder pellet holder to said first holding chamber and preheating of said predetermined amount, single application of solder to form a preheated solder pellet, and said full mode of actuation providing for movement of said preheated solder pellet from said first holding chamber to said second chamber for sequential flash heating and release of said preheated solder pellet from said soldering device onto said substrate.

26. The soldering device of claim 25 in which said dual function trigger includes a first trigger to provide for said partial mode of actuation, and a second trigger to provide for said full mode of actuation.

27. The soldering device of claim 25 further comprising a solder dispensing wheel, said solder dispensing wheel having a plurality of compartments, each said compartment sized and dimensioned for temporarily storing said predetermined amount, single application of solder, initiation of said partial mode of actuation permitting movement of said predetermined single application of solder from said compartment through an opening on said solder dispensing wheel into said first inner holding chamber.

28. The soldering device of claim 27 in which either of said partial mode of actuation or said full mode of actuation advances said solder dispensing wheel to a subsequent compartment having a new predetermined amount, single application of solder therein.

29. The soldering device of claim 27 in which said partial mode of actuation engages an internal gear drive rotatably engaging a dispensing wheel outer turning gear to rotationally advance said dispensing wheel.

30. The soldering device of claim 19 further comprising a solder dispensing wheel, said solder dispensing wheel having a plurality of compartments, each said compartment sized and dimensioned for temporarily storing a single, predetermined application solder pellet.

31. The soldering device of claim 30 in which said solder dispensing wheel is substantially circular.

32. The device for dispensing solder of claim 1 in which said predetermined size, single application solder pellets are selected from the group of solder pellets comprising a precious metal and a semi-precious metal.

33. The device for dispensing solder of claim 1 in which said predetermined size, single application solder pellets are selected from the group of a gold repair solder, a white repair solder, a pink repair solder, a green repair solder, a yellow plumb repair solder, a white plumb gold solder, a silver solder, a general plumb solder, a white plumb solder, a platinum solder, a silver solder, a standard gold solder, a standard white gold solder, a standard pink gold solder, and a standard green gold solder.

34. The device for dispensing solder of claim 1 in which said predetermined size, single application solder pellets are selected from the group of a jewelry type solder in the range of about 24K to 1K, a jewelry type solder having a flow point in the range of about 1000° F.-1600° F., and a jewelry type solder having a melting point in the range of about 1000° F.-1600° F.
